(19) United States
(12) Patent Application Publication
(10) Pub. No.: US 2013/0088878 A1
(43) Pub. Date: Apr. 11, 2013

(54) ELECTRONIC DEVICE HAVING POWER INDICATOR

(71) Applicants: YUN-LUNG CHEN, Tu-Cheng (TW); LIANG-CHIN WANG, Tu-Cheng (TW); YU-MING XIAO, Wuhan City (CN); JUN WANG, Wuhan City (CN)

(72) Inventors: YUN-LUNG CHEN, Tu-Cheng (TW); LIANG-CHIN WANG, Tu-Cheng (TW); YU-MING XIAO, Wuhan City (CN); JUN WANG, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/527,669

(22) Filed: Jun. 20, 2012

(30) Foreign Application Priority Data
Oct. 6, 2011 (CN) 201110292903.8

(51) Int. Cl. F21V 8/00

(52) U.S. Cl. 362/311.02

(57) ABSTRACT

An electronic device configured with a power indicator is presented. The electronic device includes a bezel, a light emitting diode (LED), a button assembly, and a light bar. The LED adapted to generate lights to indicate power statuses of the electronic device. The button assembly is mounted to the bezel and includes a light-conductive member which directs some of the lights out of a first side of the bezel. The light bar is mounted to the bezel and directs some of the lights out of the second side of the bezel.

### BACKGROUND

1. Technical Field

The present disclosure relates to electronic devices, and particularly to an electronic device configured with a power indicator.

2. Description of Related Art

Electronic device, such as desktop computers, are oftentimes configured with power indicators which are used to show power statuses of the electronic devices. A typical electronic device employs a light emitting diode (LED) as a power indicator which is installed in a front bezel of the electronic device. When the electronic device is down, the LED is turned off. When the electronic device is on and working normally, the LED is turned on and generates lights. However, lights from the LED can only permeate the front side of the front bezel and result in narrow viewing angles.

With the above described disadvantages in view, a need may be desired to provide an electronic device which enables a power indicator to generate lights with wider viewing angles.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an electronic device employing a power indicator in accordance with an embodiment.

FIG. 2 is similar to FIG. 1, but viewed in a different aspect.

FIG. 3 is an isometric view of a second enclosure of FIG. 2.

FIG. 4 is an assembled view of the electronic device of FIG. 1.

FIG. 5 is an assembled view of the electronic device of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

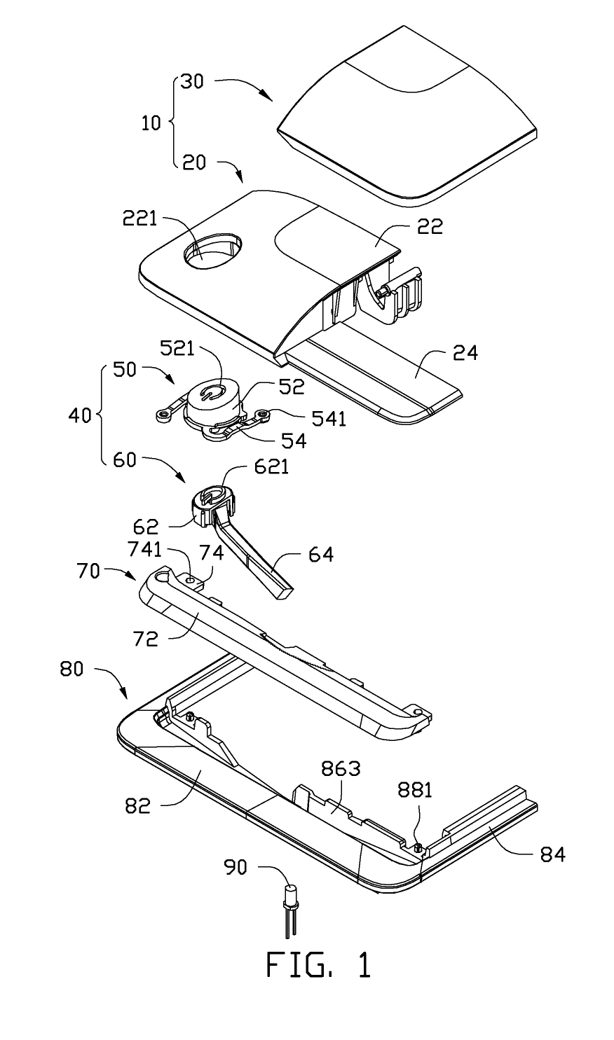

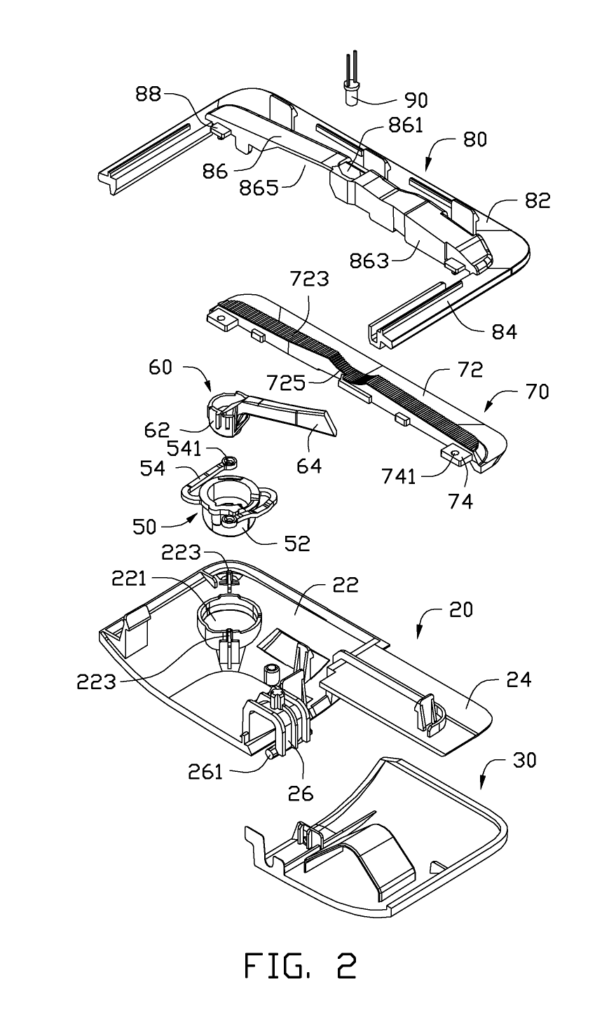

Referring to FIGS. 1-3, an electronic device employing a power indicator in accordance with an embodiment is shown. The electronic device includes a bezel 10, a button assembly 40, a light bar 70, a securing frame 80, and a light emitting diode (LED) 90. The bezel 10 includes a first enclosure 20 and a second enclosure 30. The button assembly 40 includes a pressing member 50 and a light-conductive member 60. The LED 90 may be turned on/off and generate lights to indicate power statuses of the electronic device.

The first enclosure 20 includes a main body 22 and a securing plate 24. The securing plate 24 extends from an interior side of the main body 22. The shape and size of the outer surface of the main body 22 matches the second enclosure 30. A receiving hole 221 is defined in the main body 22. The receiving hole 221 is adapted to receive the pressing member 50. Two spaced securing posts 223 protrude from the interior side of the main body 22. The two securing posts 223 are located in two opposite sides of the receiving hole 221. A U-shaped grasping member 26 protrudes from the interior side of the first enclosure 20. A cylindrical securing pole 261 is defined at a free end of the grasping member 26.

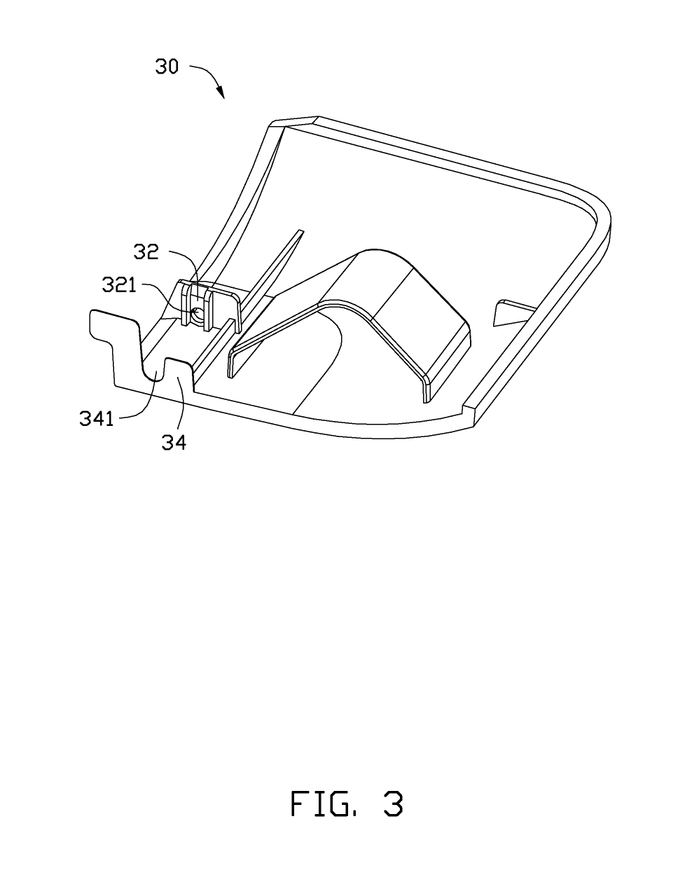

A first securing piece 32 and a second securing piece 34 protrude from an interior side of the second enclosure 30, as shown in FIG. 3. The second securing piece 34 is perpendicular to the interior side of the second enclosure 30 and extends from a backside edge of the second enclosure 30. The first securing piece 32 is parallel with the second securing piece 34. A securing hole 321 is defined in the first securing piece 32. The second securing piece 34 defines a cutout 341 corresponding to the securing hole 321. The distance between the securing hole 321 and the cutout 341 is substantially equal to the length of the securing pole 261 of the first enclosure 20.

The pressing member 50 includes a main body 52 and two resilient arms 54. The main body 52 is round-cap-shaped. The two resilient arms 54 extend from two opposite sides of the main body 52. A mounting hole 541 is defined at a free end of each of the two resilient arms 54. The two resilient arms 54 are located at the bottom of the main body 52. A light-transmitting slot 521 is defined at the top of the main body 52. The light-transmitting slot 521 is ring-shaped.

The light-conductive member 60 includes a securing portion 62 and a resilient pole 64. The securing portion 62 can be received in the main body 52 of the pressing member 50. The resilient pole 64 extends laterally from the securing portion 62. The resilient pole 64 is slant relative to the top surface of the securing portion 62. A raised portion 621 protrudes from the top surface of the securing portion 62. The raised portion 621 is ring-shaped. The raised portion 621 can be received in the light-transmitting slot 521. The light-conductive member 60 is made from light-conductive materials.

The light bar 70 includes a main body 72 and two spaced securing pieces 74. The two securing pieces 74 extends horizontally from the main body 72. A zigzag light panel 723 is defined at the bottom of the main body 72. A recess portion 725 is defined at the middle of the light panel 723. The light panel 723 is elongated and has a length substantially equal to a length of the front edge of the main body 72. The light panel 723 is made from light-scattering materials. Lights from a straight path through the light panel 723 may be scattered and go out along various paths.

The securing frame 80 includes a front border 82, two side borders 84, a connecting plate 86, and two spaced securing pieces 88. The two side borders extend laterally from the front border 82 and are perpendicular to the front border 82. The connecting plate 86 interconnects the two side borders 84. The two securing pieces 88 extends laterally from the connecting plate 86. A securing post 881 extends upwardly from each of the two securing pieces 88. The connecting plate 86 is located at the back and down side of the front border 82. A securing opening 861 is defined at the middle of the connecting plate 86. A blocking plate 863 extends upwardly from the back side edge of the connecting plate 86. A cutout 865 is defined on the blocking plate 863. The cutout 864 is adjacent to the securing opening 861.

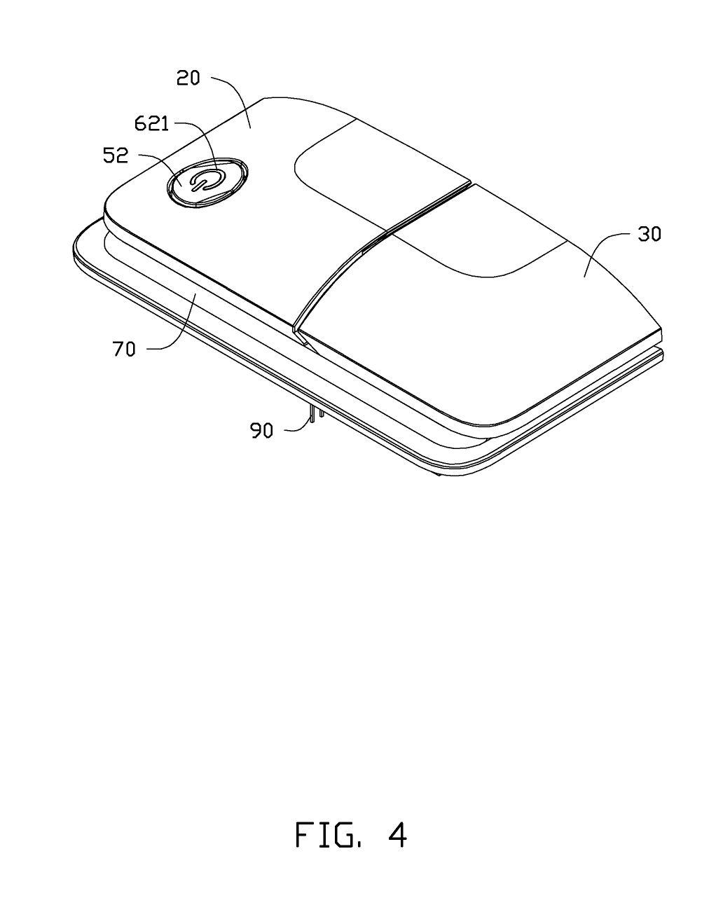

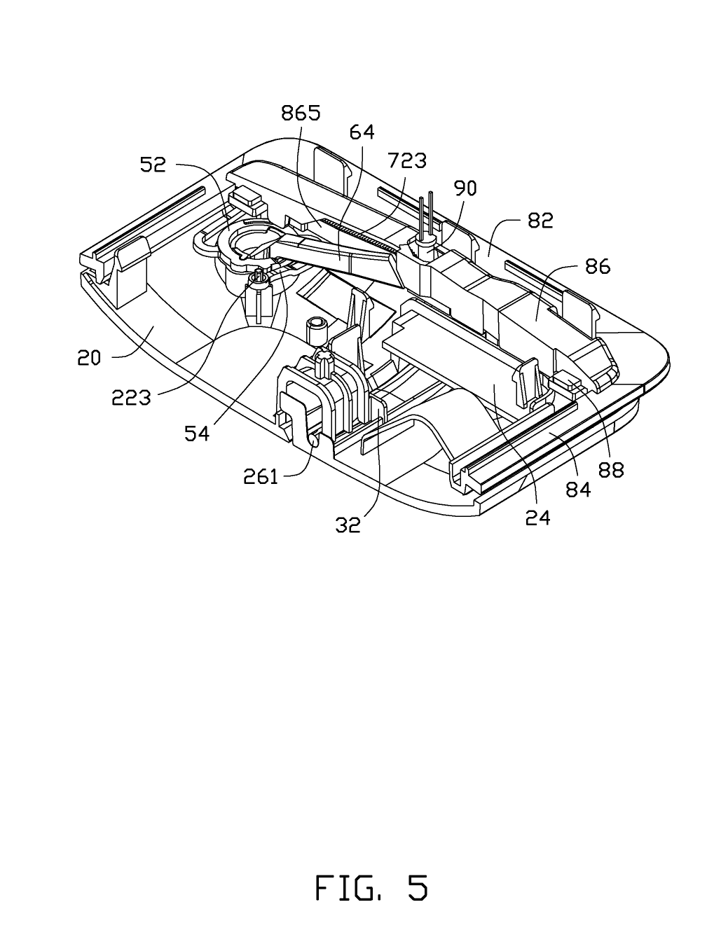

Referring to FIGS. 4 and 5, in assembly, the back end of the securing pole 261 of the first enclosure 20 is received in the cutout 341 of the second enclosure 30. The front end of the securing pole 261 is aligned with the securing hole 321 of the second enclosure 30. The first enclosure 20 is moved forwardly until the front end of the securing pole 261 is received in the securing hole 321 of the second enclosure 30. The securing plate 24 abuts the interior side of the second enclosure 30. A static frictional force is generated between the securing pole 231 and the securing hole 321 thereby fixing the second enclosure 30 to the first enclosure 20. The main body 52 of the pressing member 50 is received in the receiving hole 221 of the first enclosure 20. The two securing posts 223 of the first enclosure 20 are received in the securing holes 541 of the two resilient arms 54 thereby securing the pressing member 50 in the first enclosure 20. The raised portion 621 of the light-conductive member 60 is aligned with the light-transmitting slot 521. The securing portion 62 of the light-conductive member 60 is received in the main body 52 of the pressing member 50. The raised portion 621 of the light-conductive member 60 is inserted into the light-transmitting slot 521.

The two securing posts 881 of the securing frame 80 are aligned with the two securing holes 741 of the light bar 70 and inserted into the two securing hole 741 of the light bar 70, thereby securing the light bar 70 on the top side of the securing frame 80. The recess portion 725 of the light bar 70 is aligned with the securing opening 861. The securing frame 80 and the light bar 70 are mounted to the inside of the bezel 10. The light bar 70 is sandwiched between the securing frame 80 and the bezel 10. The front side of the light bar 70 is exposed out of the bezel 10. The length of the front side edge of the light bar 70 is the same as the length of the front side edge of the bezel 10 and also the same as the total length of the front side edge of the first enclosure 20 and the front side edge of the second enclosure 30. The resilient pole 64 of the light-conductive member 60 is received in the cutout 865 of the blocking plate 863 of the securing frame 80. The LED 90 is installed in the securing opening 861 and aligned with the recess portion 725 of the light bar 70.

When the electronic device is on and working normally, the LED 90 is turned on and generates lights. The LED 90 directs some lights laterally towards the two sides of the recess portion 725 of the light bar 70 along the light panel 723. The lights entering the light bar 70 are scattered and exit along various paths. In the meanwhile, the LED 90 directs some lights towards the resilient pole 64 of the light-conductive member 60. The lights into the light-conductive member 60 are transmitted along the light-conductive member 60 and shine out of the raised portion 621 of the light-conductive member 60. Thus, lights from the LED 90 come out through both the button assembly 40 and the light bar 70 thereby offering wider viewing angles to indicate power statuses of the electronic device.

In some embodiments, the resilient pole 64 of the light-conductive member 60 abuts another component (not shown) stored inside of the bezel 10. When the pressing member 50 is pressed down, the resilient pole 64 of the light-conductive member 60 is deformed by the stress from the pressing member 50 and exerts a force to the component. When the pressure applied to the pressing member 50 is taken off, the resilient pole 64 of the light-conductive member 60 recovers and revokes the force exerted to the component.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. An electronic device, comprising:
a bezel;
a light emitting diode (LED) adapted to generate lights to indicate power statuses of the electronic device;
a button assembly mounted to the bezel, the button assembly comprising a light-conductive member adapted to direct some of the lights out of a first side of the bezel; and
a light bar mounted to the bezel, the light bar being adapted to direct some of the lights out of a second side of the bezel.

2. The electronic device of claim 1, wherein the bezel defines a receiving hole, the button assembly comprises a pressing member received in the receiving hole, the light-conductive member comprises a securing portion received in the pressing member and a resilient pole extending laterally from the securing portion, a free end of the resilient pole is adjacent to the LED.

3. The electronic device of claim 2, wherein the pressing member comprises a top surface flushed with the bezel, the top surface defines a light-transmitting slot, the light-conductive member comprises a raised portion received in the light-transmitting slot.

4. The electronic device of claim 3, wherein the light-transmitting slot and the raised portion of the light-conductive member are ring-shaped.

5. The electronic device of claim 1, further comprising a securing frame mounted to an interior side of the bezel, the light bar is located between the bezel and the securing frame.

6. The electronic device of claim 5, wherein the light bar comprises a main body, a first securing piece extending horizontally from the main body, a zigzag light panel defined at a bottom of the main body, and a recess portion defined at middle portion of the light panel.

7. The electronic device of claim 6, wherein the securing frame comprises a front border, two side borders extending laterally from two opposite sides of the front border, and a connecting plate interconnecting each of the two side borders, the connecting plate defines a securing opening corresponding to the recess portion of the light bar, the LED is received in the securing opening of the connecting plate.

8. The electronic device of claim 7, wherein the securing frame further comprises a blocking plate extending upwardly from the connecting plate, the blocking plate defines a cutout adjacent to the securing opening of the connecting plate.

9. The electronic device of claim 8, wherein the light-conductive member further comprises a securing portion received in the pressing member and a resilient pole extending laterally from the securing portion.

10. The electronic device of claim 9, wherein the resilient pole is slant relative to a top surface of the securing portion.

11. The electronic device of claim 9, wherein the resilient pole of the light-conductive member is received in the cutout of the blocking plate.

12. The electronic device of claim 11, wherein the securing frame further comprises a second securing piece extending laterally from the connecting plate and a securing post extends upwardly from the second securing piece, the first securing piece of the light bar defines a first securing hole, the securing post is received in the first securing hole.

13. The electronic device of claim 1, wherein the bezel comprises a first enclosure and a second enclosure, the first enclosure comprises a U-shaped grasping member, a cylindrical securing pole is defined at a free end of the grasping member, the second enclosure comprises a third securing piece, the third securing piece defines a second securing hole, the cylindrical securing pole is received in the second securing hole of the third securing piece.
